(19) United States
(12) Patent Application Publication
(10) Pub. No.: US 2013/0287486 A1
(43) Pub. Date: Oct. 31, 2013

(54) ROTARY PANEL FASTENING STRUCTURE

(71) Applicant: Ying-Chih TSENG, New Taipei City (TW)

(72) Inventor: Ying-Chih TSENG, New Taipei City (TW)

(73) Assignee: HANWIT PRECISION INDUSTRIES LTD., New Taipei City (TW)

(21) Appl. No.: 13/460,286

(22) Filed: Apr. 30, 2012

(51) Int. Cl. F16D 1/108

(52) U.S. Cl. 403/314

(57) ABSTRACT

A rotary panel fastening structure includes a mating socket mounted in a through hole in a recessed accommodation chamber in a top wall of a first panel member, a locking knob, a connection plate fastened to the locking knob and a handle pivotally connected to the connection plate and receivable in the recessed accommodation chamber in a flush manner and operable to rotate the locking knob through 90° angle between an unlocking position where the locking knob is movable with the first panel member in and out of a slot of a second panel member and a locking position where the locking knob is engaged with the second panel member to lock the first panel member and the second panel member together.

### BACKGROUND OF THE INVENTION

1. Field of the Invention

The present invention relates to fasteners for joining panel members and more particularly, to a rotary panel fastening structure, which comprises a mating socket mounted in a first panel member, a locking knob coupled to the matching socket and holding a connection plate, and a handle pivotally connected to the connection plate and operable to rotate the locking knob between a locking position to lock the first panel member to a second panel member and an unlocking position to unlock the first panel member from the second panel member.

2. Description of the Related Art

Screws or pins are commonly used in many different products for locking movable members. For example, a lock pin may be used to lock a sliding box or board member when the sliding rails of the sliding box or board member are moved relative to respective sliding grooves to a predetermined position, facilitating wiring, or movement or transportation of the equipment. In a desk computer system, industrial computer system, work station or any other equipment where movable plate members are detachably arranged together, screws or pins may also be used to lock the movable plate members together, facilitating mounting and dismounting.

Further, as shown in FIGS. 11 and 12, a server case A generally comprises a front cover shell A1, a back cover shell A2 and a partition panel A3. The front cover shell A1 and the back cover shell A2 are respectively covered on the top side of the front chamber and back chamber of the server case A. The back cover shell A2 comprises a front flange A21 attached to a flange A31 of the partition panel A3, and a plurality of locating grooves A22 respectively coupled to respective protruding portions A32 of the partition panel A3. The front cover shell A1 comprises a plurality of retaining members A11 respectively engaged into respective retaining grooves A33 of the partition panel A3. Thus, the front cover shell A1 and back cover shell A2 can be slidably moved relative to the partition panel A3 into an engaged condition. However, this engagement design is not highly stable. There is no any locking means to lock the front cover shell A1, the back cover shell A2 and the partition panel A3 in the engaged condition. When the worker moves the server case A, the front cover shell A1 or the back cover shell A2 may be moved relative to the partition panel A3, or disengaged from the partition panel A3. Further, this one direction engagement design cannot firmly secure the front cover shell A1 and the back cover shell A2 in position. When the server case is tilted during delivery, the front cover shell A1 or the back cover shell A2 may be forced away from the partition panel A3 accidentally. Therefore, an improvement in this regard is necessary.

### SUMMARY OF THE INVENTION

The present invention has been accomplished under the circumstances in view. According to one aspect of the present invention, a rotary panel fastening structure comprises a first panel member with a through hole, a mating socket mounted in the through hole of the first panel member, a second panel member defining a slot, a locking knob mounted in the mating socket and defining a longitudinal cut plane and an arched peripheral wall on a locking tip at a bottom side of a shank thereof, a connection plate fastened to the locking knob, and a handle connected to the connection plate and operable to rotate the locking knob through 90° angle between an unlocking position where the locking knob is movable with the first panel member in and out of the slot of the second panel member and a locking position where the locking knob is engaged with the second panel member to lock the first panel member and the second panel member together.

According to another aspect of the present invention, the connection plate comprises a center hole cut through the opposing top and bottom walls thereof for the passing of the shank and locking tip of the locking knob and two radial notches radially aligned at two opposite lateral sides relative to the center hole. Further, the handle comprises a grip, two handle arms extended from said grip, and two coupling tips respectively curved from the handle arms and respectively pivotally coupled to the radial notches of the connection plate. Thus, the handle can be biased relative to the connection plate and the locking knob between a horizontal position where the handle is received in a recessed accommodation chamber in the top wall of the first panel member in a flush manner to reduce the height of the whole structure, and a vertical position where the handle is conveniently operable to rotate the locking knob between the locking position and the unlocking position.

According to still another aspect of the present invention, the first panel member further comprises an arched upright wall portion disposed in the recessed accommodation open chamber at one side, a first stop edge disposed in the recessed accommodation open chamber at one lateral side of the arched upright wall portion and adapted for stopping the rotary locking knob in the locking position, and a second stop edge disposed in the recessed accommodation open chamber at an opposite lateral side of the arched upright wall portion and adapted for stopping the rotary locking knob in the unlocking position.

### BRIEF DESCRIPTION OF THE DRAWINGS

FIG. 1 is an oblique top elevation of a rotary panel fastening structure in accordance with the present invention.

FIG. 2 is an exploded view of the rotary panel fastening structure in accordance with the present invention.

FIG. 3 corresponds to FIG. 2 when viewed from another angle.

FIG. 4 is a sectional side view of the rotary panel fastening structure in accordance with the present invention.

FIG. 5 is a schematic applied view of the present invention, illustrating the mating socket and the rotary locking device installed in the first panel member before attachment of the first panel member to the second panel member.

FIG. 6 is a schematic sectional side view of the present invention, illustrating the first panel member and the second panel member attached together and the rotary locking device rotated to the unlocking position.

FIG. 7 corresponds to FIG. 6, illustrating the rotary locking device rotated to the locking position.

FIG. 8 is a schematic perspective view of the present invention, illustrating the first panel member and the second panel member attached together and the rotary locking device rotated between the unlocking position and the locking position.

FIG. 9 is an exploded view of an alternate form of the rotary panel fastening structure in accordance with the present invention.

FIG. 10 is a schematic sectional side view of the alternate form of the rotary panel fastening structure in accordance with the present invention.

FIG. 11 is an elevational exploded view of a conventional server case.

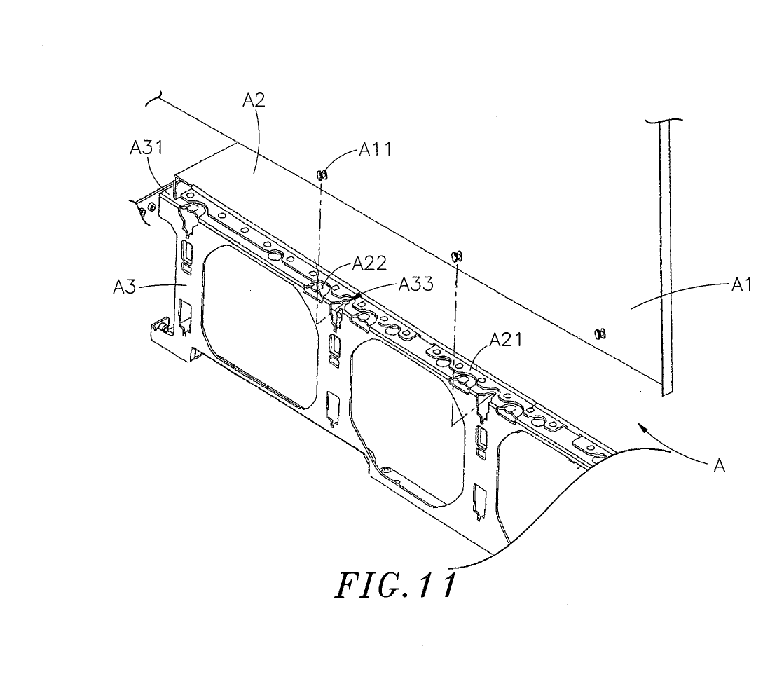

FIG. 12 is a schematic sectional side view, in an enlarged scale, of a part of FIG. 11.

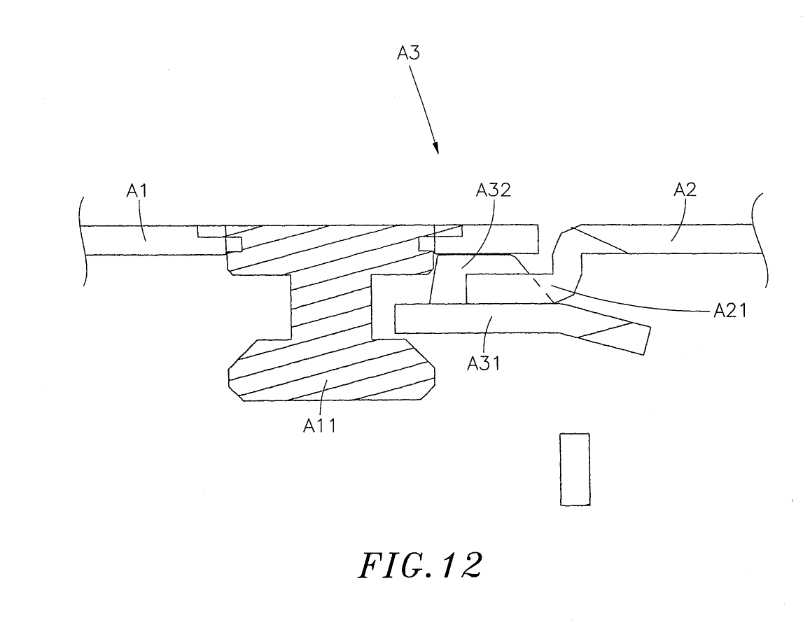

### DETAILED DESCRIPTION OF THE PREFERRED EMBODIMENT

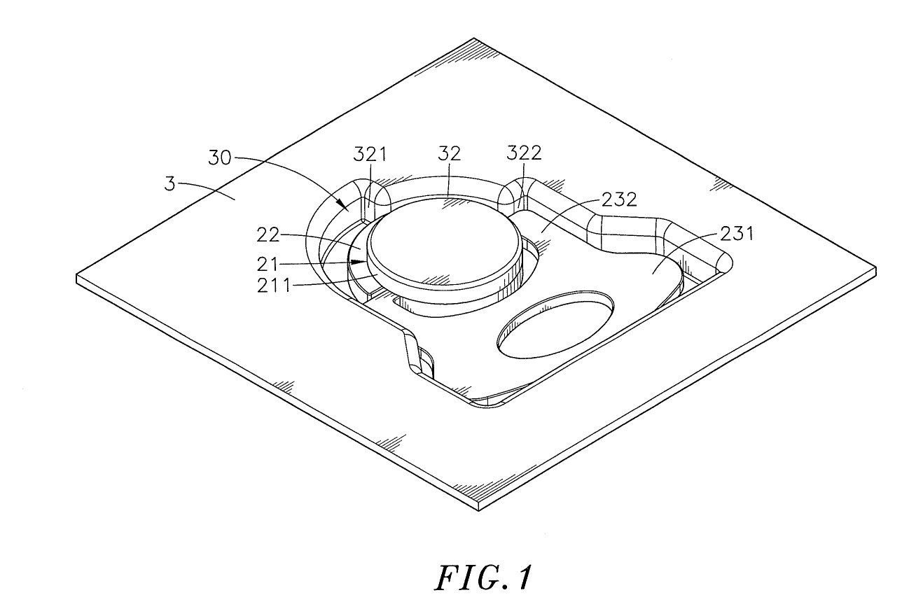

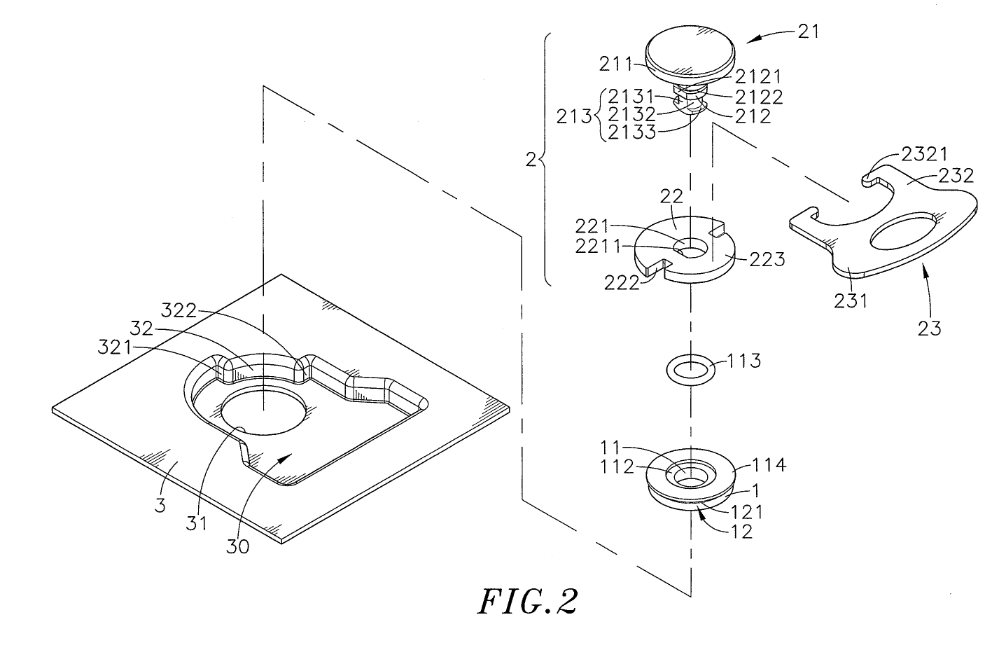

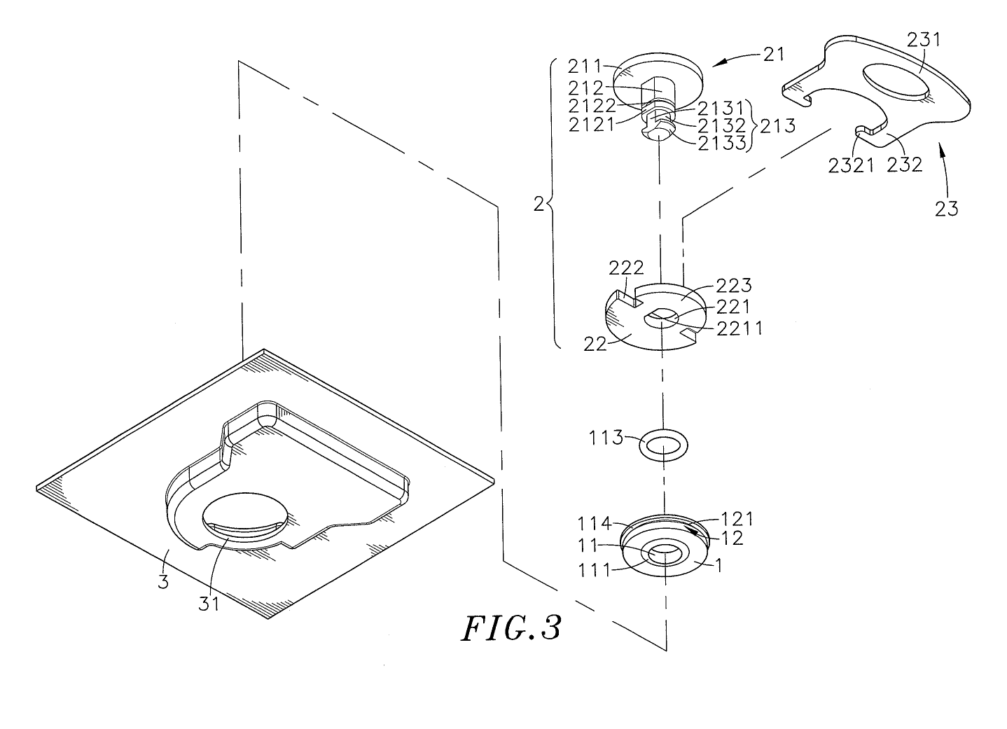

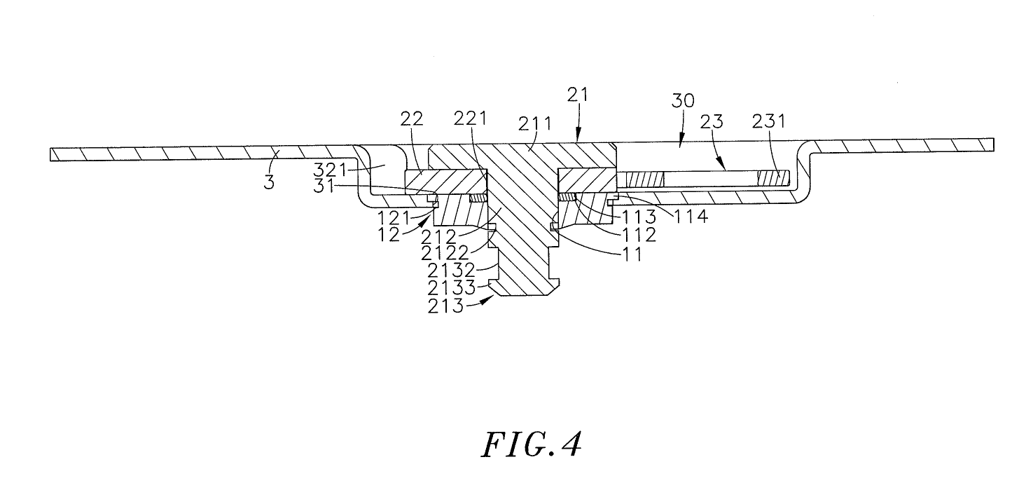

Referring to FIGS. 1-4, a rotary panel fastening structure in accordance with the present invention is shown comprising a mating socket 1 and a rotary locking device 2.

The mating socket 1 comprises a cylindrical body 12, a circular through hole 11 cut through opposing top and bottom walls of the cylindrical body 12, an annular bottom flange 111 protruded from the bottom wall of the cylindrical body 12 around the circular through hole 11, an annular top groove 112 located on the top wall of the cylindrical body 12 around the circular through hole 11 and accommodating a gasket ring 113, a rim 114 extending around the periphery of the cylindrical body 12 in flush with the top wall thereof, and a locating groove 121 extending around the periphery of the cylindrical body 12 at the bottom side of the rim 114.

The rotary locking device 2 comprises a locking knob 21, a connection plate 22 fastened to the locking knob 21, and a handle 23 pivotally coupled to the connection plate 22 and operable to rotate the locking knob 21 and the connection plate 22 between a locking position and an unlocking position. The locking knob 21 comprises a head 211, a shank 212 perpendicularly extended from the center of the bottom wall of the head 211 and inserted through the circular through hole 11 of the mating socket 1, and a locking tip 213 axially extended from the distal end of the shank 212. The shank 212 comprises a first longitudinal cut plane 2121 located on the periphery thereof, and an annular groove 2122 extending around the periphery near the distal end (i.e., adjacent to the locking tip 213). The locking tip 213 comprises a second longitudinal cut plane 2131 located on the periphery thereof corresponding to the first longitudinal cut plane 2121, an arched peripheral wall 2132 abutted against the second longitudinal cut plane 2131 at the same elevation, and a stop block 2133 extending around of the bottom edge of the arched peripheral wall 2132 beyond the second longitudinal cut plane 2131.

The connection plate 22 is coupled to the shank 212 of the locking knob 21 between the head 211 of the locking knob 21 and the mating socket 1, comprising a center hole 221 cut through the opposing top and bottom walls thereof for the passing of the shank 212 and locking tip 213 of the locking knob 21, a thrust plane 2211 located on the inside wall thereof within the center hole 221 for abutting against the first longitudinal cut plane 2121 of the locking knob 21, two radial notches 222 radially aligned at two opposite lateral sides relative to the center hole 221, and a sector block 223 disposed around the center hole 221 in proximity to the radial notches 222.

The handle 23 comprises a grip 231, two handle arms 232, and two coupling tips 2321 respectively curved from the handle arms 232 and respectively pivotally coupled to the radial notches 222 of the connection plate 22.

Further, the bottom wall of the head 211 of the locking knob 21 is stopped at the connection plate 22 and the coupling tips 2321 of the handle 23. Further, according to the present preferred embodiment, the locking knob 21 and the connection plate 22 are two separate members coupled together. Alternatively, the locking knob 21 and the connection plate 22 can be made in integrity. By means of the connection plate 22, the handle 23 is coupled to the locking knob 21 and biasable relative to the locking knob 21 between a horizontal position and a vertical position.

During the assembly process of the rotary panel fastening structure, couple the two coupling tips 2321 of the handle 23 to the radial notches 222 of the connection plate 22, and then insert the locking tip 213 and shank 212 of the locking knob 21 through the center hole 221 of the connection plate 22 to abut the first longitudinal cut plane 2131 against the thrust plane 2211, and then insert the locking tip 213 and shank 212 of the locking knob 21 through the circular through hole 11 of the mating socket 1 to force the connection plate 22 against the gasket ring 113 in the annular top groove 112 of the connection plate 1. After the annular groove 2122 of the locking knob 21 passed over the annular bottom flange 111 of the mating socket 1, a stamping tool is used to stamp the annular bottom flange 111 of the mating socket 1 into engagement with the annular groove 2122 of the locking knob 21. At this time, the rotary locking device 2 is connected to the mating socket 1 and can be rotated relative to the mating socket 1. Further, the gasket ring 113 is stopped at the bottom wall of the connection plate 22 against the head 211 of the locking knob 21, enhancing the structural stability of the rotary panel fastening structure.

Thereafter, the rotary panel fastening structure of the mating socket 1 and the rotary locking device 2 is installed in a first panel member 3. The first panel member 3 comprises a recessed accommodation open chamber 30 formed in the top wall thereof, a through hole 31 cut through the opposing top and bottom walls thereof and disposed in the recessed accommodation open chamber 30, an arched upright wall portion 32 disposed in the recessed accommodation open chamber 30 adjacent to and spaced around the through hole 31, a first stop edge 321 disposed in the recessed accommodation open chamber 30 at one lateral side of the arched upright wall portion 32, and a second stop edge 322 disposed in the recessed accommodation open chamber 30 at an opposite lateral side of the arched upright wall portion 32.

During installation of the rotary panel fastening structure, insert the cylindrical body 12 of the mating socket 1 into the through hole 31 of the first panel member 3 to have the rim 114 be stopped at the top side of the bottom wall of the recessed accommodation open chamber 30 of the first panel member 3 around the border edge of the through hole 31, and then use a tool to rivet the border edge of the through hole 31 to the locating groove 121 of the mating socket 1. Thus, the mating socket 1 is rotatably coupled to the through hole 31 of the first panel member 3. At this time, the handle 23 can be biased relative to the connection plate 22 and the locking knob 21 from the vertical position to the horizontal position and rested in the recessed accommodation open chamber 30 of the first panel member 3 in a flush manner. Thus, the assembly of the rotary panel fastening structure and the first panel member 3 has a low profile.

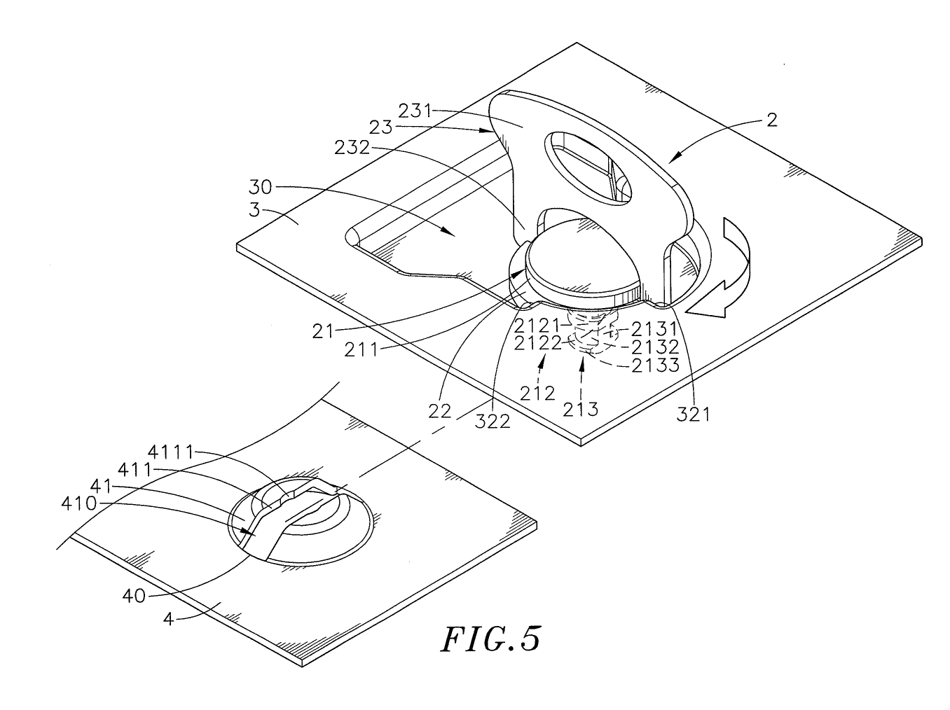

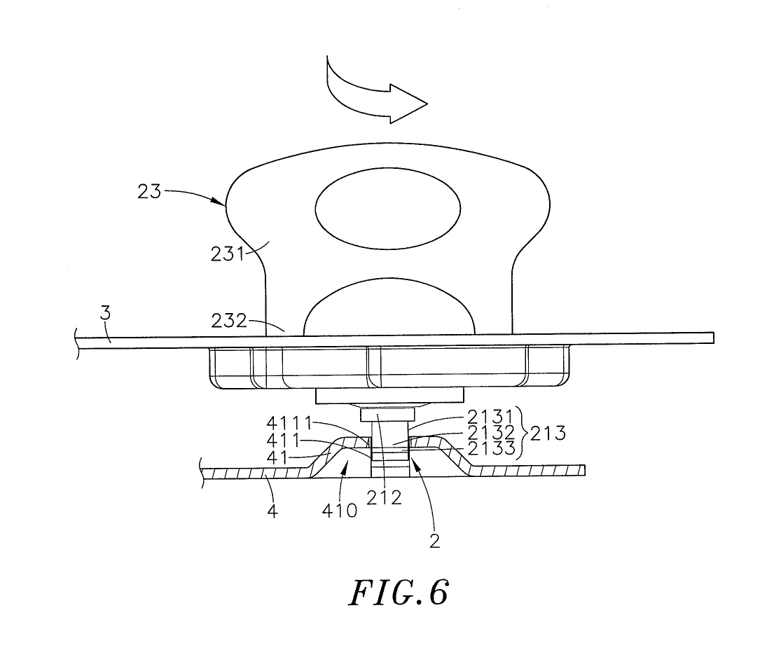

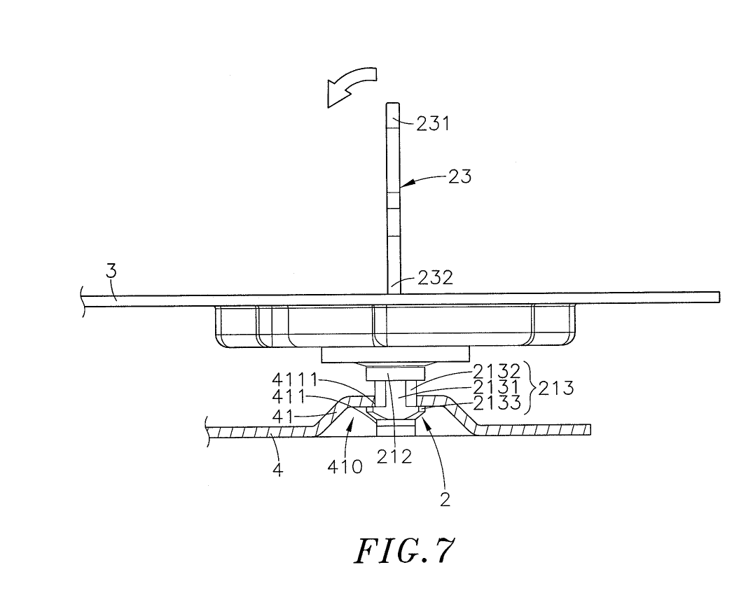

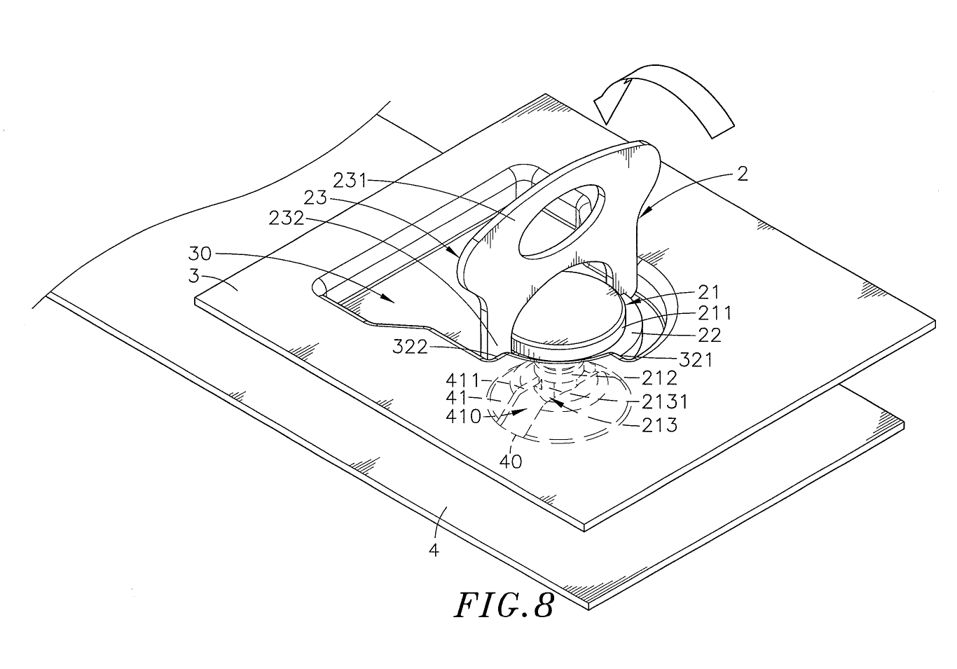

Referring to FIGS. 5-8, the rotary panel fastening structure is fastenable to a second panel member 4 to lock the first panel member 3 to the second panel member 4. The second panel member 4 comprises an opening 40 corresponding to the through hole 31 of the first panel member 3, a protruding frame member 41 protruded from the border of the opening 40 and defining a locking space 410 in the opening 40, a slot 411 cut through the protruding frame member 41, and an arched notch 4111 formed in the protruding frame member 41 at one lateral side of the slot 411.

During application of the present invention, lift the grip 231 of the handle 23 from the horizontal position to the vertical position, and then rotate the grip 231 through 90° angle to move the handle 23 away from the second stop edge 322 of the first panel member 3 into abutment with the first stop edge 321. At this time, the connection plate 22 and the locking knob 21 are rotated with the handle 23. Thereafter, move the second panel member 4 to the bottom side of the first panel member 3 (or move the first panel member 3 to the top side of the second panel member 4 to force the shank 212 and locking tip 213 of the locking knob 21 into the slot 411 of the protruding frame member 41 and to have one side edge of the slot 411 of the protruding frame member 41 be abutted against the second longitudinal cut plane 2131 of the locking tip 213 of the locking knob 21, and then rotate the grip 231 in the reversed direction through 90° angle to move the handle 23 away from the first stop edge 321 of the first panel member 3 into abutment with the second stop edge 322 and to force the vertex of the arched peripheral wall 2132 of the locking tip 213 into engagement with the arched notch 4111 and the stop block 2133 of the locking tip 213 into engagement with the bottom wall of the protruding frame member 41. Thus, the stop block 2133 is locked in the locking space 410, preventing disconnection of the locking tip 213 of the locking knob 21 of the rotary locking device 2 from the rotary from the slot 411 of the protruding frame member 41 of the second panel member 4 accidentally upon an external shearing force.

When going to release the second panel member 4 from the first panel member 3, rotate the grip 231 of the handle 23 of the rotary locking device 2 through 90° angle away from the second stop edge 322 of the first panel member 3 to the first stop edge 321 to disengage the stop block 2133 of the locking tip 213 from the bottom wall of the protruding frame member 41 and the vertex of the arched peripheral wall 2132 of the locking tip 213 from the arched notch 4111 of the protruding frame member 41. At this time, the second longitudinal cut plane 2131 of the locking tip 213 of the locking knob 21 is kept in a parallel manner relative to one side edge of the slot 411 of the protruding frame member 41, allowing removal of the second panel member 4 from the first panel member 3. By means of rotating the handle 23 through 90° angle, the locking tip 213 of the locking knob 21 is moved into engagement with the slot 411 of the protruding frame member 41 or disengaged from the slot 411 of the protruding frame member 41.

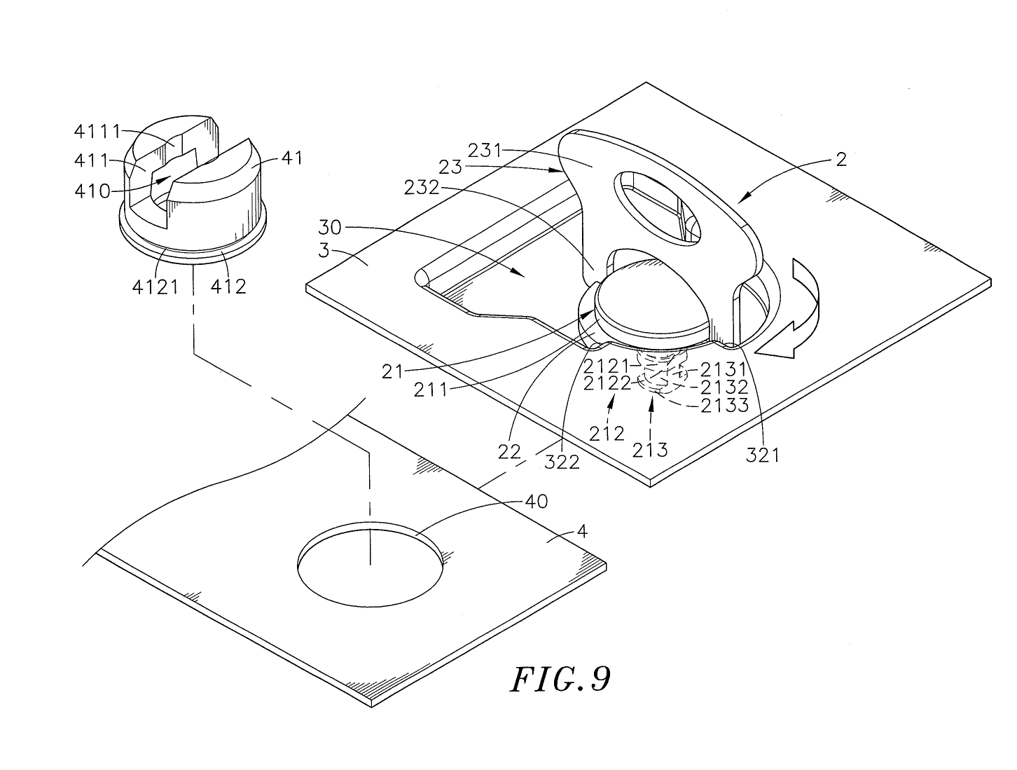

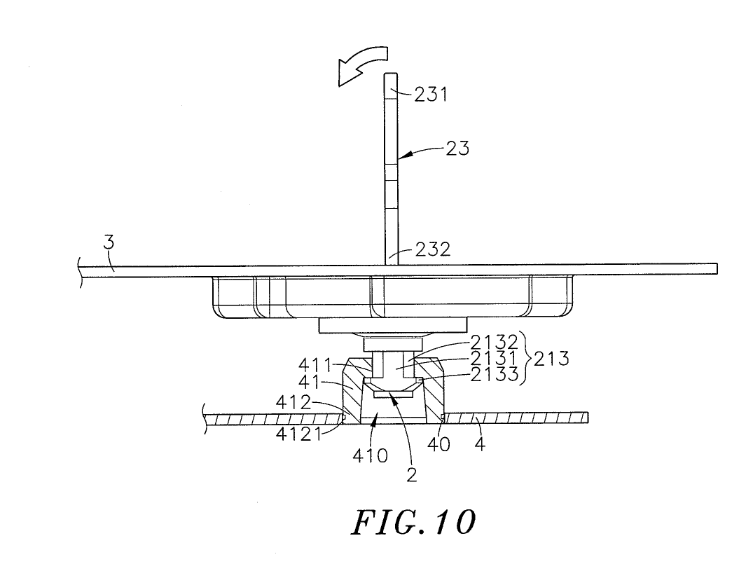

FIGS. 9 and 10 illustrate an alternate form of the present invention. According to this alternate form, the protruding frame member 41 is an independent member fixedly fastened to the opening 40 of the second panel member 4 by a soldering or riveting process. In addition to the structural features of locking space 410, slot 411 and arched notch 4111, the protruding frame member 41 further comprises a mounting flange 412 extending around the periphery of the bottom side thereof, and a mounting groove 4121 extending around the periphery and abutted against the mounting flange 412. By means of the mounting groove 4121 and the mounting flange 412, the protruding frame member 41 can be conveniently affixed to the opening 40 of the second panel member 4 by a soldering or riveting process.

Although particular embodiments of the invention have been described in detail for purposes of illustration, various modifications and enhancements may be made without departing from the spirit and scope of the invention.

What the invention claimed is:

1. A rotary panel fastening structure mounted in a through hole of a first panel member for detachably fastening said first panel member to a second panel member, the rotary panel fastening structure comprising:
a mating socket comprising a cylindrical body mounted in said first panel member, and a circular through hole cut through opposing top and bottom walls of said cylindrical body; and
a rotary locking device mounted in said mating socket and rotatable to lock said first panel member to said second panel member, said rotary locking device comprising a locking knob, a connection plate fastened to said locking knob and a handle pivotally connected to said connection plate and rotatable to move said locking knob between a locking position and an unlocking position, said locking knob comprising a head supported on said connection plate, a shank perpendicularly extended from the center of a bottom wall of said head and inserted through said circular through hole of said mating socket, and a locking tip axially extended from said shank, said locking tip comprising a longitudinal cut plane located on the periphery thereof and a stop block extending around of a bottom edge thereof beyond said longitudinal cut plane.

2. The rotary panel fastening structure as claimed in claim 1, wherein said locking knob further comprises an annular groove extending around the periphery of said shank near said locking tip; said mating socket further comprises an annular bottom flange protruded from the bottom wall of said cylindrical body around said circular through hole and coupled to the annular groove of said locking knob.

3. The rotary panel fastening structure as claimed in claim 1, wherein said mating socket further comprises an annular top groove located on the top wall of said cylindrical body around said circular through hole and accommodating a gasket ring, a rim extending around the periphery of said cylindrical body in flush with the top wall of said cylindrical body and supported on said first panel member, and a locating groove extending around the periphery of said cylindrical body and riveted to said first panel member.

4. The rotary panel fastening structure as claimed in claim 1, wherein said connection plate comprises a center hole cut through the opposing top and bottom walls thereof for the passing of said shank of said locking knob and two radial notches radially aligned at two opposite lateral sides relative to the center hole; said handle comprises a grip, two handle arms extended from said grip, and two coupling tips respectively curved from said handle arms and respectively pivotally coupled to said radial notches of said connection plate.

5. The rotary panel fastening structure as claimed in claim 4, wherein said shank of said locking knob comprises a longitudinal cut plane; said connection plate comprises a thrust plane located on an inside wall thereof within said center hole and abutted against the longitudinal cut plane of said shank of said locking knob.

6. A rotary panel fastening structure, comprising:
a first panel member comprising a through hole;
a mating socket mounted in the through hole of said first panel member, said mating socket comprising a cylindrical body mounted in said first panel member, and a circular through hole cut through opposing top and bottom walls of said cylindrical body;
a second panel member comprising an opening, a protruding frame member protruded from the border of said opening and a slot cut through said protruding frame member; and
a rotary locking device mounted in said mating socket and rotatable to lock said first panel member to said second panel member, said rotary locking device comprising a locking knob, a connection plate fastened to said locking knob and a handle pivotally connected to said connection plate and rotatable to move said locking knob between an unlocking position where said locking knob is movable with said first panel member in and out of said slot of said second panel member and a locking position where said locking knob is engaged with said protruding frame member of said second panel member, said locking knob comprising a head supported on said connection plate, a shank perpendicularly extended from the center of a bottom wall of said head and inserted through said circular through hole of said mating socket, and a locking tip axially extended from said shank, said locking tip comprising a longitudinal cut plane located on the periphery thereof and a stop block extending around of a bottom edge thereof beyond said longitudinal cut plane.

7. The rotary panel fastening structure as claimed in claim 6, wherein said locking knob further comprises an annular groove extending around the periphery of said shank near said locking tip; said mating socket further comprises an annular bottom flange protruded from the bottom wall of said cylindrical body around said circular through hole and coupled to the annular groove of said locking knob.

8. The rotary panel fastening structure as claimed in claim 6, wherein said mating socket further comprises an annular top groove located on the top wall of said cylindrical body around said circular through hole and accommodating a gasket ring, a rim extending around the periphery of said cylindrical body in flush with the top wall of said cylindrical body and supported on said first panel member, and a locating groove extending around the periphery of said cylindrical body and riveted to said first panel member.

9. The rotary panel fastening structure as claimed in claim 6, wherein said connection plate comprises a center hole cut through the opposing top and bottom walls thereof for the passing of said shank of said locking knob and two radial notches radially aligned at two opposite lateral sides relative to the center hole; said handle comprises a grip, two handle arms extended from said grip, and two coupling tips respectively curved from said handle arms and respectively pivotally coupled to said radial notches of said connection plate.

10. The rotary panel fastening structure as claimed in claim 9, wherein said shank of said locking knob comprises a longitudinal cut plane; said connection plate comprises a thrust plane located on an inside wall thereof within said center hole and abutted against the longitudinal cut plane of said shank of said locking knob.

11. The rotary panel fastening structure as claimed in claim 6, wherein said first panel member comprises a recessed accommodation open chamber formed in a top wall thereof, an arched upright wall portion disposed in said recessed accommodation open chamber adjacent to and spaced around the through hole of said first panel member, a first stop edge disposed in said recessed accommodation open chamber at one lateral side of said arched upright wall portion and adapted for stopping said rotary locking device in said locking position, and a second stop edge disposed in said recessed accommodation open chamber at an opposite lateral side of said arched upright wall portion and adapted for stopping said rotary locking device in said unlocking position; the through hole of said first panel member is formed in said recessed accommodation open chamber; said rotary locking device is receivable in said recessed open chamber in flush with the top wall of said first panel member.

12. The rotary panel fastening structure as claimed in claim 6, wherein said protruding frame member of said second panel member defines a locking space in said opening for accommodating said stop block of said locking knob.

13. The rotary panel fastening structure as claimed in claim 6, wherein said locking tip comprises an arched peripheral wall abutted against said longitudinal cut plane at a same elevation; said protruding frame member of said second panel member defines an arched notch at one lateral side of said slot.

14. The rotary panel fastening structure as claimed in claim 6, wherein said protruding frame member of said second panel member further comprises a mounting flange extending around the periphery of a bottom side thereof and stopped at a bottom side of said second panel member around said opening, and a mounting groove extending around the periphery and coupled to the periphery of said opening of said second panel member.
